(19) United States
(12) Patent Application Publication
(10) Pub. No.: US 2025/0022355 A1
(43) Pub. Date: Jan. 16, 2025

(54) ANTI-THEFT SYSTEM

(71) Applicant: James Slyter, Houston, TX (US)

(72) Inventor: James Slyter, Houston, TX (US)

(21) Appl. No.: 18/220,060

(22) Filed: Jul. 10, 2023

(51) Int. Cl. G08B 13/00; G06Q 20/10

(52) U.S. Cl. CPC G08B 13/00; G06Q 20/1085

(57) ABSTRACT

An anti-theft system for deterring and preventing theft from automated teller machines includes an automated teller assembly that stores monetary bills, a tampering detection unit, and a dye delivery system. The automated teller assembly includes a computer. The tampering detection unit is mounted on the automated teller assembly and electrically coupled to the computer. The tampering detection unit can detect unauthorized access to the automated teller assembly, including seismic vibrations or tilting of the machine, temperature changes associated with torches or drills used to breach the machine, and flammable gasses. The dye delivery system is electrically coupled to the computer and can dispense dye on the monetary bills within seconds after tampering is detected.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to anti-theft system and more particularly pertains to a new anti-theft system for deterring and preventing theft from automated teller machines.

### (2) Description of Related Art Including Information Disclosed Under 37 CFR 1.97 and 1.98

The prior art relates to anti-theft systems for use in an automated teller machine.

### BRIEF SUMMARY OF THE INVENTION

An embodiment of the disclosure meets the needs presented above by generally comprising an automated teller assembly that stores monetary bills, a tampering detection unit, and a dye delivery system. The automated teller assembly includes a computer. The tampering detection unit is mounted on the automated teller assembly and electrically coupled to the computer. The tampering detection unit can detect unauthorized access to the automated teller assembly, including seismic vibrations or tilting of the machine, temperature changes associated with welding torches or drills used to breach the machine, and flammable gasses. The dye delivery system is electrically coupled to the computer and can dispense dye on the monetary bills within seconds after tampering is detected.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an anti-theft system according to an embodiment of the disclosure.

FIG. 2 is a front view of an embodiment of the disclosure.

FIG. 3 is a partial cross-sectional view of an embodiment of the disclosure.

FIG. 4 is a side view of an embodiment of the disclosure.

FIG. 5 is an in-use view of an embodiment of the disclosure.

### DETAILED DESCRIPTION OF THE INVENTION

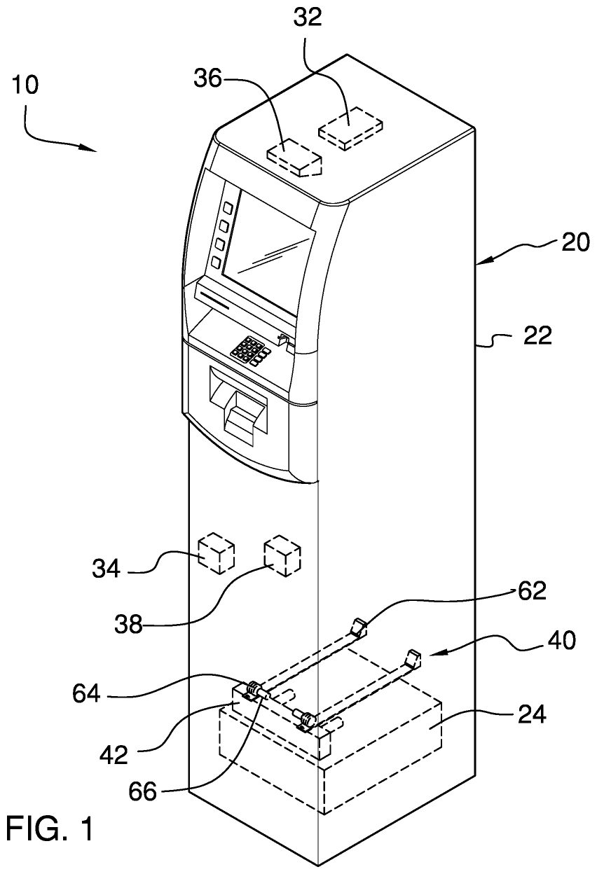

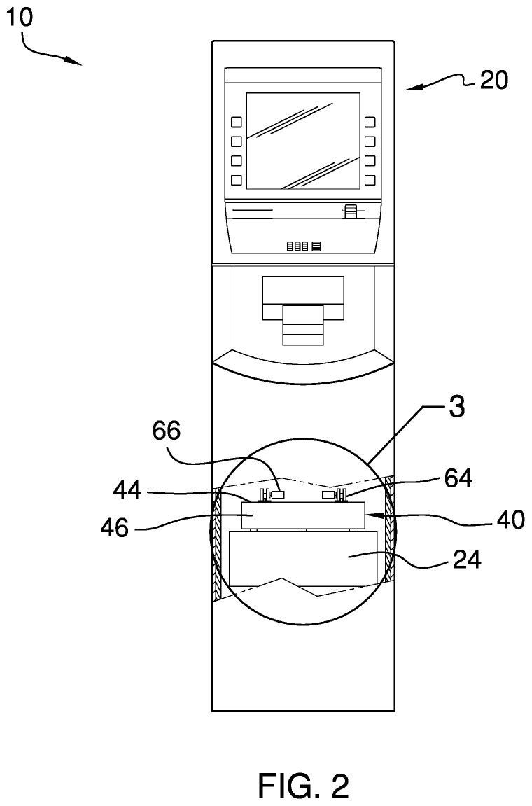

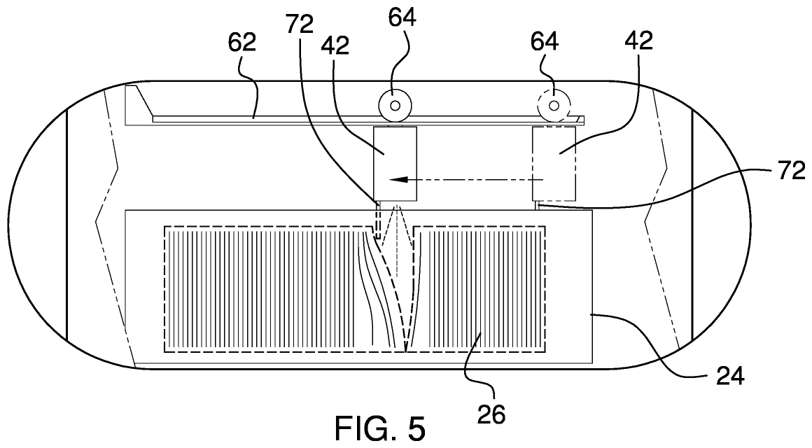

With reference now to the drawings, and in particular to FIGS. 1 through 5 thereof, a new anti-theft system embodying the principles and concepts of an embodiment of the disclosure and generally designated by the reference numeral 10 will be described.

As best illustrated in FIGS. 1 through 5, the anti-theft system 10 generally comprises an automated teller assembly 20, a tampering detection unit 30, and a dye delivery system 40.

The automated teller assembly 20 is generally conventional and configured for dispensing monetary bills 26. The automated teller assembly includes an automated teller housing 22. A plurality of bill cartridges 24 are mounted in the automated teller housing 22. Each of the bill cartridges 24 houses a plurality of monetary bills 26. A bill retrieving apparatus (not shown) is configured to selectively remove the monetary bills 26 from the bill cartridges 24 and dispense the monetary bills 26 outwardly from the automated teller housing 22. A computer (not shown) is electrically coupled to the bill retrieving apparatus.

A tampering detection unit 30 is mounted on the automated teller assembly 20 and is electrically coupled to the computer. The tampering detection unit 30 is configured to detect unauthorized access to the automated teller housing 22.

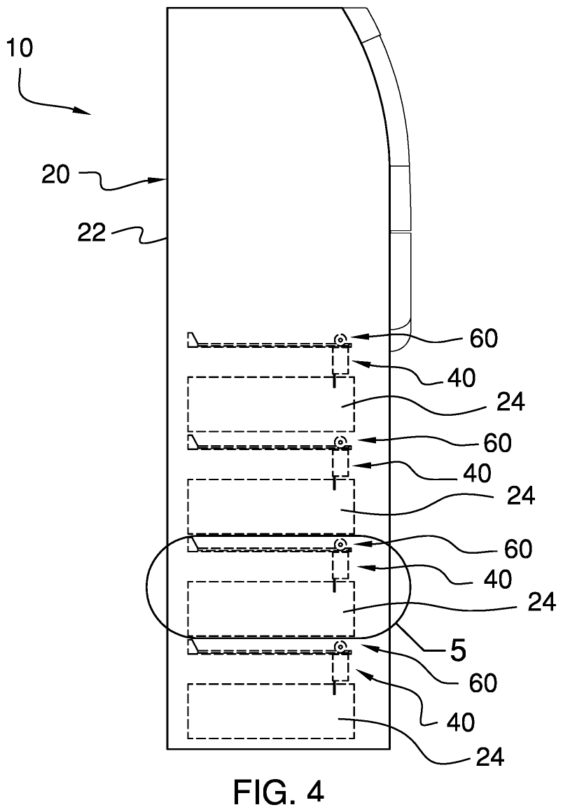

A dye delivery system 40 is electrically coupled to the computer. The dye delivery system 40 is in communication with the plurality of bill cartridges 24 and is configured to dispense dye on the monetary bills 26 when the tampering detection unit 30 detects the unauthorized access to the automated teller housing 22. Some embodiments, such as the one shown in FIG. 4, include a plurality of dye delivery systems 40, wherein each of the plurality of dye delivery systems 40 are installed above each of the plurality of bill cartridges 24.

The tampering detection unit 30 may include a tilt sensor 32 that is installed on the automated teller assembly 20. The tilt sensor 32 is configured to periodically measure a current tilt of the automated teller assembly 20. For example, the tilt sensor 32 may measure the current tilt every few minutes. In other embodiments, the tilt sensor 32 may continuously measure the current tilt. The dye delivery system 40 is actuated to dispense dye when the tilt sensor 32 detects an angle greater than a threshold angle. In some embodiments, the threshold angle is at least greater than 5°, while in other embodiments the threshold angle may be at least greater than 10°, or even greater. The threshold angle may be determined based on the location of the automated teller assembly 20 and the tilt of the ground or platform upon which the automated teller assembly 20 is placed. The tilt sensor 32 is generally configured to detect shaking or movement of the automated teller assembly 20. For example, if the automated teller assembly 20 is pushed over or pulled from where it's standard position, the tilt sensor 32 is generally configured to recognize that movement as unauthorized access to the automated teller assembly 20.

The tampering detection unit 30 may also include a heat sensor 34 installed on the automated teller assembly 20. The heat sensor 34 is configured to measure a current ambient temperature of the automated teller assembly 20. The dye delivery system 40 is actuated to dispense dye when the heat sensor 34 detects a temperature greater than a threshold temperature. In exemplary embodiments, the threshold temperature is at least greater than 200° F. The threshold temperature may be determined based on the average ambient temperature in the location of the automated teller assembly 20. The heat sensor 34 is generally configured to recognize when the current ambient temperature is so elevated from the standard environmental temperature that destruction, damage, or other tampering efforts may be occurring to the automated teller assembly 20. For example, the heat sensor 34 may be configured to recognize a temperature elevation that occurs when a blow torch, terminal lance, drill, or other instrument of destruction is used on the automated teller assembly 20.

The tampering detection unit 30 may also include a flammable gas detector 38 installed on the automated teller assembly 20. The flammable gas detector 38 is configured to measure a current ambient gas level of the automated teller assembly 20. When the flammable gas detector 38 detects a flammable gas level greater than a threshold gas level, the dye delivery system 40 is actuated to dispense dye over the monetary bills 26. The flammable gas detector 38 may comprise a conventional detector that can recognize increased levels of flammable gases from the standard environmental levels. Generally, the flammable gas detector 38 is configured to detect the presence of flammable or explosive gases that may be used in an attempted theft and to recognize the presence of those gases as unauthorized access to the automated teller assembly 20.

The tampering detection unit 30 may further include an alarm 36 installed on the automated teller assembly 20 and electrically coupled to the computer. The alarm 36 may be configured to emitting an ear shattering noise when the tampering detection system recognizes actual or attempted unauthorized access to the automated teller assembly 20. For example, the noise emitted by the alarm 36 may range between 65 dB and 120 dB. The alarm 36 may be configured to continue emitting the noise until police or another authorized entity confirms the unauthorized access has ceased, or did not occur, and manually turns off the alarm 36. The alarm 36 may also frighten potential thieves away from the automated teller assembly 20, or the alarm 36 may alert police or other surrounding individuals of the attempted theft. Thus, the attempted theft may be aborted or the potential thieves may be apprehended more quickly and easily because the alarm will bring near-instantaneous attention to the crime scene.

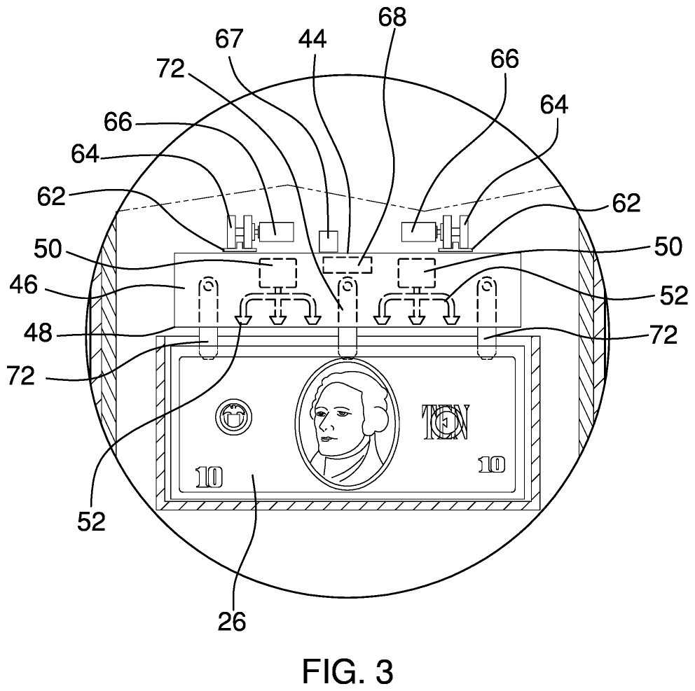

The dye delivery system 40 may include a dye delivery housing 42, a dye cartridge 50, a spray nozzle 52, and a drive mechanism 60. The dye delivery housing 42 generally includes a top panel 44 and a perimeter wall 46 that is attached to and extends downwardly from the top panel 44. The perimeter wall 46 has a bottom edge 48 defining an opening extending into the dye delivery housing 42. In some embodiments, the top panel 44 has a rectangular shape. The dye cartridge 50 is mounted to the dye delivery housing 42 and stores the dye. The spray nozzle 52 is in fluid communication with the dye cartridge 50. The spray nozzle 52 is configured to draw the dye from the dye cartridge 50 and dispense the dye on the monetary bills 26. In some embodiments, such as the one shown in FIG. 3, the dye delivery system 40 includes two dye cartridges 50 and two spray nozzles 52.

The drive mechanism 60 is mounted to the dye delivery housing 42. The drive mechanism 60 is actuated in a forward direction and a reverse direction to drive the dye cartridge 50 over the entire length of the bill cartridge 24. The drive mechanism 60 further comprises a rail 62 mounted to the dye delivery housing 42. A roller 64 may be coupled to the rail 62. For example, the rail 62 may extend over the entire length of the bill cartridge 24. The roller 64 is configured to smoothly travel along the rail 62, urging the dye delivery system 40 along the length of the bill cartridge 24. A motor 66 is mounted to the roller 64 and configured to transfer electric energy from a power supply 67 electrically coupled to the motor 66 into mechanical energy that urges the roller 64 along the rail 62. Some exemplary embodiments of the power supply 67 are lithium-ion batteries or solar-charged batteries. The power supply 67 may be separate and distinct from the power supply of the automated teller assembly 20 so that the dye delivery system can function even if power to the automated teller assembly 20 is interrupted. The power supply 67 may also be configured to maintain a long-term charge, such as a charge lasting five or ten years, without needing to be recharged or replaced. A control panel 68 is electrically coupled to the motor 66 and to the tampering detection unit 30. The control panel 68 is configured to activate the drive mechanism 60 and the dye delivery system 40 when the tampering detection unit 30 detects unauthorized access.

The dye delivery system 40 may further comprise a plurality of separators 72 that are attached to and extend downwardly beyond the bottom edge 48 toward the plurality of bill cartridges 24. The plurality of separators 72 is configured to make physical contact with each of the plurality of monetary bills 26, partially separating them from one another as the dye delivery system 40 moves in the forward direction and the reverse direction along the rail 62. The plurality of separators 72 ensures the dye can contact at least two sides of the monetary bills 26 and ensures that each and every one of the plurality of monetary bills 26 is coated in dye after an unauthorized access attempt.

In use, the tampering detection unit 30 recognizes when unauthorized access to the automated teller assembly 20 is attempted. As described above, the tampering detection unit 30 is generally configured to recognize a range of unauthorized access attempts, including moving, destroying, and breaking into the automated teller assembly 20. Within just a few seconds of recognizing attempted unauthorized access, the dye delivery system 40 initiates dispensing dye over the monetary bills 26. Because the roller 64 can quickly and smoothly move the dye cartridge 50 over the rail 62, each of the plurality of monetary bills 26 can be coated in dye almost immediately after unauthorized access is detected. If the potential thieves do manage to extract monetary bills 26 from the automated teller assembly 20, those monetary bills 26 will be covered in the dye, allowing the monetary bills 26 to be traced back to the automated teller assembly 20 and the theft. The alarm 36 can also immediately begin emitting noise, which may scare the potential thieves away from the machine or alert nearby persons of the attempted theft. The combination of these anti-theft elements can deter crime and can make catching the criminals easier.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An anti-theft system configured for preventing theft of monetary bills, the system comprising:
an automated teller assembly for dispensing monetary bills, the automated teller assembly including:
an automated teller housing;
a plurality of bill cartridges being mounted in the automated teller housing, each of the bill cartridges having a plurality of monetary bills therein;
a bill retrieving apparatus being configured to selectively remove the monetary bills from the bill cartridges and dispense the monetary bills outwardly from the automated teller housing;
a computer being electrically coupled to the bill retrieving apparatus;
a tampering detection unit being mounted on the automated teller assembly and being electrically coupled to the computer, the tampering detection unit being configured to detect unauthorized access to the automated teller housing; and
a dye delivery system being electrically coupled to the computer, the dye delivery system being in communication with the plurality of bill cartridges and being configured to dispense dye on the monetary bills when the tampering detection unit detects the unauthorized access to the automated teller housing.

2. The anti-theft system of claim 1, the tampering detection unit further comprising:
a tilt sensor being installed on the automated teller assembly, the tilt sensor being configured to measure a current tilt of the automated teller assembly, wherein the dye delivery system is actuated to dispense dye when the tilt sensor detects an angle greater than a threshold angle, wherein the threshold angle is at least greater than 5°; and
a heat sensor installed on the automated teller assembly, the heat sensor being configured to measure a current ambient temperature of the automated teller assembly, wherein the dye delivery system is actuated to dispense dye when the heat sensor detects a temperature greater than a threshold temperature, wherein the threshold temperature is at least greater than 200° F.

3. The anti-theft system of claim 2, the dye delivery system further comprising a plurality of dye delivery systems, wherein each of the plurality of dye delivery systems is installed above each of the plurality of bill cartridges.

4. The anti-theft system of claim 2, wherein the threshold angle is at least greater than 10°.

5. The anti-theft system of claim 3, the dye delivery system further comprising:
a dye delivery housing including a top panel and a perimeter wall being attached to and extending downwardly from the top panel, the perimeter wall having a bottom edge defining an opening extending into the dye delivery housing, the top panel having a rectangular shape;
a dye cartridge being mounted to the dye delivery housing, the dye cartridge storing the dye;
a spray nozzle being in fluid communication with the dye cartridge, the spray nozzle being configured to draw the dye from the dye cartridge and dispense the dye on the monetary bills; and
a drive mechanism being mounted to the dye delivery housing, the drive mechanism being actuated in a forward direction and a reverse direction to drive the dye cartridge over each of the bill cartridges.

6. The anti-theft system of claim 5, the drive mechanism further comprising:
a rail mounted to the dye delivery housing;
a roller coupled to the rail, the roller being configured to smoothly travel along the rail;
a motor being mounted to the roller;
a power supply being electrically coupled to the motor to actuate the motor in the forward direction and the reverse direction; and
a control panel being electrically coupled to the motor and to the tampering detection unit, the control panel being configured to activate the drive mechanism and the dye delivery system when the tampering detection unit detects the angle or the temperature.

7. The anti-theft system of claim 6, wherein the power supply is a DC power source such as a lithium-ion battery or a solar cell.

8. The anti-theft system of claim 5, the dye delivery system further comprising:
a plurality of separators being attached to and extending downwardly beyond the bottom edge toward the plurality of bill cartridges, the plurality of separators being configured to make physical contact with the monetary bills to partially separate the monetary bills from one another as the dye delivery system moves in the forward direction and the reverse direction along the rail, thereby ensuring the dye can contact at least two sides of the monetary bills.

9. The anti-theft system of claim 1, the tampering detection unit further comprising:
an alarm electrically installed on the automated teller assembly, the alarm being coupled to the computer, the alarm emitting a noise ranging between 65 dB and 120 dB, the alarm being configured to activate when the tampering detection unit detects the unauthorized access to the automated teller housing.

10. The anti-theft system of claim 1, the tampering detection unit further comprising:
a flammable gas detector installed on the automated teller assembly, the flammable gas detector being configured to measure a current ambient gas level of the automated teller assembly, wherein the dye delivery system is actuated to dispense dye when the flammable gas detector detects a flammable gas level greater than a threshold gas level.
